(19) United States
(12) Patent Application Publication
(10) Pub. No.: US 2007/0157817 A1
(43) Pub. Date: Jul. 12, 2007

(54) AIR PURIFYING DEVICE

(76) Inventor: Swei-Yuan Lee, Tainan (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/306,829

(22) Filed: Jan. 12, 2006

(51) Int. Cl. B01D 47/00

(52) U.S. Cl. 96/294

(57) ABSTRACT

An air purifying device includes at least one liquid-absorptive filtering core, a sterilizing liquid contained in the filtering core, and a liquid container for supplying the sterilizing liquid to the filtering core. The sterilizing liquid includes a nonionic detergent and a free radical releasing agent. The filtering core includes a porous foam sheet with a high void ratio and a plurality of highly absorptive cotton threads that are uniformly distributed on the foam sheet and that form carriers for the sterilizing liquid. When the air purifying device is mounted in an inlet or upstream side of a mask or an air circulating path of an air conditioner, the hazardous pollutants in the air can be filtered and the bacteria and virus in the air can be killed, thereby purifying the air.

### BACKGROUND OF THE INVENTION

1. Field of the Invention

The present invention relates to an air purifying device. More particularly, the present invention relates to an air purifying device that can be mounted in an inlet of a mask or an air circulating path of an air conditioner, air cleaner, insulating tent, or other air conditioning equipment, and particularly to a filtering core and sterilizing liquid for an air purifying device.

2. Description of the Related Art

It is well known that air often contains bacteria and/or virus that, if not effectively filtered or killed, would propagate via droplets or air circulation and thus pollute the environment and adversely affect the health of human body. To improve the air quality, currently available air cleaners and air conditioners generally include an air purifier to filter the suspended particles and pollutants in the air. A conventional air purifier includes a nonwoven or foam sheet as the filtering material and uses active charcoal or an electrostatic filtering net to absorb suspended particles in the air. Hence, the air sucked into the air purifier is filtered and circulated, and clean air is output after purification.

The absorption provided by the filtering material and the active charcoal may remove the suspension particles in the air but fails to effectively filter micro virus and/or bacteria. The filtering material in an ordinary mask or the filtering net in an air cleaner is also insufficient to stop invasion of virus whereas ordinary filtering material and active charcoal could not provide the required sterilizing effect and thus could not be used in a highly hazardous, infective environment.

On the other hand, although a conventional nanometric light-catalyzed device attached to the filtering net of an air cleaner may provide the sterilizing function and deodorizing function, it could not work without radiation by ultraviolet rays, has a complicated structure, and is costly.

### SUMMARY OF THE INVENTION

The primary objective of the present invention is to provide an air purifying device that comprises a filtering core with excellent sterilizing effect. More specifically, the filtering core is highly sterilizing, highly air-permeable, and uniformly liquid-absorptive. The air purifying device has a simple structure and can be mounted in an inlet of a mask or an air circulating path of an air conditioner, air cleaner, insulating tent, or other air conditioning equipment. The bacteria and virus in the air can be effectively filtered and killed by the air purifying device.

The air purifying device in accordance with the present invention comprises at least one liquid-absorptive filtering core, a sterilizing liquid contained in the filtering core, and a liquid container for supplying the sterilizing liquid to the filtering core. The sterilizing liquid includes a nonionic detergent and a free radical releasing agent. The filtering core includes a porous foam sheet with a high void ratio and a plurality of highly absorptive cotton threads that are uniformly distributed on the foam sheet and that form carriers for the sterilizing liquid. When the air purifying device is mounted in an inlet or upstream side of a mask or an air circulating path of an air conditioner, the hazardous pollutants in the air can be filtered and the bacteria and virus in the air can be killed, thereby purifying the air.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of an embodiment of an air purifying device in accordance with the present invention.

FIG. 2 is an enlarged perspective view of a filtering core of the air purifying device in accordance with the present invention.

FIG. 3 is a perspective view of an air conditioner equipped with the air purifying device in accordance with the present invention.

FIG. 4 is a schematic sectional view illustrating operation of the air purifying device in the air conditioner in FIG. 3.

FIG. 5 is a schematic sectional view illustrating use of the air purifying device in accordance with the present invention in a filter container for use with a mask.

FIG. 6 is a sectional view of the filter container in FIG. 5.

FIG. 7 is an exploded perspective view of the filter container in FIG. 6.

### DETAILED DESCRIPTION OF THE INVENTION

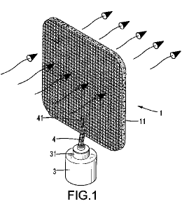

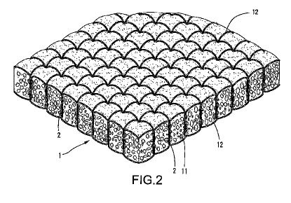

Referring to FIGS. 1 and 2, an air purifying device in accordance with the present invention comprises at least one liquid-absorptive filtering core 1, a sterilizing liquid 2 contained in the filtering core 1, and a liquid container 3 for supplying the sterilizing liquid 2 to the filtering core 1.

The sterilizing liquid 2 includes a nonionic detergent such as nonident P-40 (NP-40) and a free radical releasing agent such as a hydroxy radical releasing agent. The nonionic detergent is a protein denaturant that is capable of denaturizing the protein coats of the virus and separating the proteins from the nucleic acids of the virus. The hydroxyl radical releasing agent is capable of decomposing all organic matters including proteins, nucleic acids, fats, and carbohydrates.

The filtering core 1 includes a porous foam sheet 111 with a high void ratio and a plurality of highly absorptive cotton threads 12. Referring to FIG. 2, the cotton threads 12 are uniformly distributed on the foam sheet 11 and form carriers for the sterilizing liquid 2. Alternatively, the foam sheet 11 may be replaced with a filtering cotton net with a high void ratio, and the cotton threads 12 can be replaced with other strings that are highly absorptive for liquid.

The liquid container 3 is a bottle or the like having an opening 31. The sterilizing liquid 2 is filled into the liquid container 3. The liquid container 3 further includes at least one string 4 (such as a cotton thread) that has an inner end extending through the opening 31 into the liquid container 3, with an outer end of the string 4 in contact with the filtering core 1. Hence, the sterilizing liquid 2 in the liquid container 3 can be supplied to the filtering core 1 along the string 4 via capillary action.

In the air purifying device in accordance with the present invention, the foam sheet 111 with a high void ratio is advantageous to flow of air whereas the uniformly distributed cotton threads 12 provide a large area for absorption of the sterilizing liquid 2, which compensates the poor liquid absorption of the foam sheet 11. Thus, the filtering core 1 has uniform moistness. Preferably, the cotton threads 12 of the filtering core 1 are sufficiently dense to allow formation of a sterilizing-liquid-absorbing layer in the foam sheet 111 but sufficiently sparse to allow smooth flow of air.

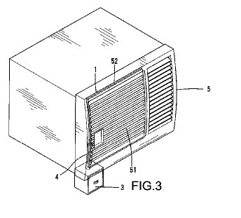

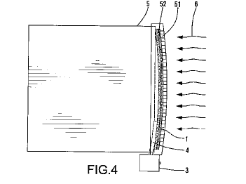

FIGS. 3 and 4 illustrate installation of the air purifying device in accordance with the present invention in an air circulating path of an air conditioner 5. The filtering core 1 is mounted in an inlet 51 of the air conditioner 5. A conventional filtering net 52 can be mounted in front of the filtering core 1 for removing suspended particles in the air.

When the air currents enter the inlet 51 along the direction indicated by arrows 6 in FIG. 4, the air is firstly filtered by the filtering net 52 and then passes through the filtering core 1. The bacteria and virus in the air are killed by the sterilizing liquid 2 uniformly distributed in the filtering core 1. The nonionic detergent in the sterilizing liquid 2 denaturizes the protein coats of the virus and separates the proteins from the nucleic acids of the virus whereas the hydroxyl radical releasing agent in the sterilizing liquid 2 decomposes the nucleic acids and proteins into harmless carbon dioxide and water. When the amount of the sterilizing liquid 2 in the filtering core 1 reduces, the sterilizing liquid 2 in the liquid container 3 is supplied to the filtering core 1 via the string 4, providing a lasting sterilizing effect.

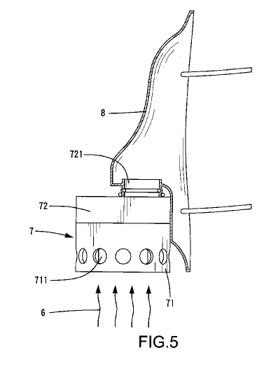

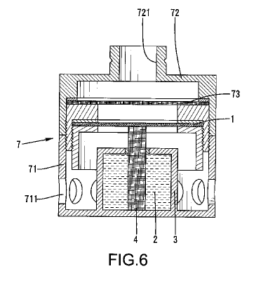

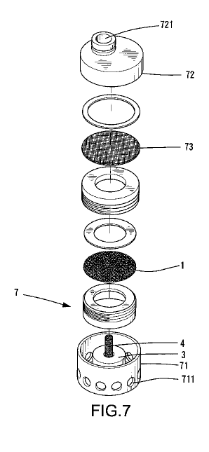

FIGS. 5 through 7 illustrate installation of the air purifying device in accordance with the present invention in a filter container 7 for use with a mask 8. The filter container 7 includes a body 71 and a cap 72. The body 71 includes a plurality of inlets 711 and the cap 72 includes at least one outlet 721. The outlet 721 is coupled to the mask 8 so that air purified by the filtering core 1 can flow into the mask 8. In this example, at least one filtering material 73 is mounted in the body 71 for removing suspended particles in the air.

When the air currents enter the inlets 711 along the direction indicated by arrows 6 in FIG. 5, the air passes through the filtering core 1. The bacteria and virus in the air are killed by the sterilizing liquid 2 uniformly distributed in the filtering core 1. The purified air enters the mask 8 via the outlet 721, providing clean, virus-free air to the wearer of the mask 8. Similarly, when the amount of the sterilizing liquid 2 in the filtering core 1 reduces, the sterilizing liquid 2 in the liquid container 3 is supplied to the filtering core 1 via the string 4, providing a lasting sterilizing effect.

It is noted that the air purifying device in accordance with the present invention is not limited to be mounted in an inlet of a filter container of a mask or an inlet of an air conditioner. The air purifying device in accordance with the present invention can be mounted in, e.g., an inlet or upstream side of an air circulating path of an air cleaner, insulating tent, or other air conditioning equipment.

Although specific embodiments have been illustrated and described, numerous modifications and variations are still possible without departing from the essence of the invention. The scope of the invention is limited by the accompanying claims.

What is claimed is:

1. An air purifying device comprising:
at least one liquid-absorptive filtering core including a porous foam sheet with a high void ratio and a plurality of highly absorptive cotton threads that are uniformly distributed on the foam sheet;
a sterilizing liquid contained in the filtering core and capable of decomposing organic matters; and
a liquid container including the sterilizing liquid filled therein, the liquid container further including at least one liquid-absorptive string inserted into the liquid container for supplying the sterilizing liquid to the filtering core.

2. The air purifying device as claimed in claim 1 wherein the sterilizing liquid includes a nonionic detergent and a free radical releasing agent.

3. The air purifying device as claimed in claim 1 wherein the nonionic detergent is nonident P-40 (NP-40).

4. The air purifying device as claimed in claim 1 wherein the free radical releasing agent is a hydroxy radical releasing agent.

5. The air purifying device as claimed in claim 1 wherein the liquid container is a bottle having an opening, said at least one string including an inner end extending through the opening into the liquid container, with an outer end of the string in contact with the filtering core for supplying the sterilizing liquid in the liquid container to the filtering core via said at least one string.

6. The air purifying device as claimed in claim 1 wherein the filtering core is adapted to be mounted in an inlet of an air conditioner.

7. The air purifying device as claimed in claim 1 wherein the filtering core is adapted to be mounted in a filter container and used with a mask.
